(19) United States
(12) Patent Application Publication
(10) Pub. No.: US 2017/0267099 A1
(43) Pub. Date: Sep. 21, 2017

(54) VEHICLES FOR PROVIDING VIRTUAL ENVIRONMENTS

(71) Applicant: Calay Venture S.à r.l., Bettembourg (LU)

(72) Inventor: Cevat Yerli, Frankfurt am Main (DE)

(21) Appl. No.: 15/073,463

(22) Filed: Mar. 17, 2016

(51) Int. Cl. B60K 35/00; B60W 40/08

(52) U.S. Cl. CPC B60K 35/00; B60W 40/08

(57) ABSTRACT

A vehicle for carrying at least one passenger is disclosed. The vehicle comprises at least one support mechanism for carrying a passenger of the vehicle. Each support mechanism includes at least one sensor attached to the passenger for measuring parameters of the passenger in relation to an environment of the vehicle and at least one display device for the passenger for displaying a virtual environment to the passenger based on the measured parameters of the passenger. Furthermore, an amusement ride and a method for displaying a virtual environment in a vehicle are described.

### TECHNICAL FIELD

The present disclosure relates to a vehicle, an amusement ride, and a method for displaying a virtual environment in a vehicle. In particular, the present disclosure may relate to speed-based virtual reality attractions.

### BACKGROUND

In virtual reality or augmented reality systems, a user is provided with information representing a virtual environment, such as a rendering of the virtual environment or acoustical data related to the virtual environment, which provides the user with a sensation of a physical presence in places in the real world or an imagined world. However, most virtual reality and augmented reality devices are bound to a local (real) environment and, therefore, typically only represent a local experience of the virtual environment. For example, a user may walk with respect to a virtual reality display, such as in a CAVE virtual environment with projections on multiple walls, or a user may move around in a room using a head-mounted display device or a see-through device. The user may be tracked to determine a position and orientation of the user's head in order to provide representations of the virtual environment that correspond to a viewing perspective of the user.

However, virtual reality and augmented reality approaches typically fail to provide a realistic experience of fast moving virtual environments, such as a ride through the virtual environment. Even though the motion can be simulated in the virtual environment, the user typically remains in the local (real) environment. Since the user does not experience any acceleration in the real environment, the perception of the moving virtual environment may cause a sensory mismatch in the user, which may lead to undesirable effects, which are typically referred to as motion or simulator sickness. This degrades the experience of the virtual environment.

Therefore, it is an object of the present disclosure to improve provision of virtual environments.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The problem is solved by a vehicle, an amusement ride, and a method for displaying a virtual environment in a vehicle as disclosed herein.

A first aspect of the present disclosure provides a vehicle for carrying at least one passenger, comprising at least one support mechanism, each support mechanism for carrying a passenger of the vehicle and each support mechanism including at least one sensor attached to the passenger for measuring parameters of the passenger in relation to the environment of the vehicle, and at least one display device for the passenger for displaying a virtual environment to the passenger based on the measured parameters of the passenger.

The vehicle may be any kind of car, vessel or craft suitable for moving and/or rotating the passenger in the (real) environment. The motion or rotation of the vehicle may be guided, such as using flumes or tracks, or by mounting the vehicle to a rotational and/or translational assembly, including one or more of arms, axles, joints or other rotating and translating members. The vehicle may ride, float or fly in any combination. Hence, the vehicle may move and rotate the passenger through the (real) environment in any direction and orientation.

The passengers of the vehicle are carried in respective support mechanisms, wherein each support mechanism carries one passenger of the vehicle. Each support mechanism includes the at least one sensor, which is attached to the passenger and measures parameters of the passenger in relation to the environment of the vehicle. The sensor is associated with the support mechanism of the vehicle; however, it provides parameters of the passenger with regard to the (real) environment. By directly measuring parameters of the passenger in relation to the environment of the vehicle, the measurement may more accurately reflect a current sensory perception or state of the passenger. The measured parameters are more robust than parameters which are measured in relation to the vehicle.

The support mechanism further includes at least one display device for the passenger that displays the virtual environment to the passenger based on the measured parameters of the passenger. The measured parameters may indicate a change of (sensory) state of the passenger with regard to the (real) environment, which may influence a simulation of the virtual environment and a respective rendering of the virtual environment to be displayed on the display device of the user.

The display devices may provide the virtual environment in a way that corresponds to the current (sensory) state of the passenger with regard to the (real) environment. Since the vehicle changes the position and orientation of the passenger with regard to the (real) environment, the passenger experiences rotational and translational forces. Because this displacement and these forces are correctly reflected in the displayed virtual environment, the real and the simulated virtual environments match and, therefore, provide a realistic perception of the virtual environment, without the known undesired effects of sensory mismatch in passengers.

The at least one display device may be configured to display the virtual environment according to one or more modalities, including the visual modality, the acoustic modality, the haptic modality, the olfactoric modality or the gustatoric modality, in any combination, by presenting respective stimuli. Hence, the display device is not restricted to presentation of visual stimuli. Rather, the at least one display device may include one or more monitors for providing (stereoscopic) images, one or more earphones, loudspeakers or a loudspeaker array for providing sound, one or more force feedback devices, and the like, in any combination. Hence, the display device may stimulate a plurality of senses of the passenger in a natural and immersive way, thereby providing a sensation of presence in the (simulated) virtual environment to the passenger.

The provided stimuli may completely replace the stimuli of the (real) environment, which may also be referred to as virtual reality (VR). The stimuli of the virtual environment may overlay at least a part of the (real) environment, which may also be referred to as augmented reality (AR) or mixed reality. This results in an enrichment of the (real) environment with the virtual environment or a replacement of at least a part of the (real) environment with the virtual environment in a synchronous and matching way based on the displacement of the passenger in the vehicle.

In one embodiment, the vehicle is connected to at least one processing device for simulating the virtual environment for each passenger according to the measured parameters of the passenger. The at least one processing device may render the simulated virtual environment. Preferably, the rendering generates a media stream for each passenger, which is then streamed to the respective at least one display device for the passenger. The at least one processing device may include memory for storing instructions and a processor for executing the instructions. For example, the processing device may execute a real-time 3D engine for simulating the virtual environment.

The virtual environment may define a virtual scene including one or more virtual objects that may behave in the virtual scene according to simulated physical laws and properties and/or according to the measured parameters. For example, the virtual scene may support a simulation of collisions of virtual objects, of forces on virtual objects, and the like. The virtual objects may further include properties for enabling highly realistic rendering of the virtual objects in the virtual scene in real time. This may take into account a realistic simulation of light conditions in the virtual scene and the like. The virtual scene may be rendered according to a camera perspective that may be determined according to the measured parameters of the passenger with regard to the environment of the vehicle. Hence, the simulated virtual environment may have a realistic appearance and may correspond to the sensation the passenger is experiencing in the moving or rotating vehicle.

The simulation of the virtual environment may be further influenced by input of the passenger who may, for example, interact with individual virtual objects of the virtual scene. For example, the passenger may operate one or more input devices, such as a force feedback device, a pointing device, or a touch-sensitive device, or by providing indirect input, for example, by tracking limbs of the passenger, which may be used to affect simulation of individual virtual objects within the virtual scene of the virtual environment. This provides for a highly realistic interaction with a displayed virtual environment for each individual passenger of the vehicle.

Since the simulation of the virtual environment for each individual passenger is done on the central processing device using one or more dedicated simulation and rendering engines, and since the final rendering is provided as a media stream to the respective display devices of the passenger, the support mechanism for an individual passenger does not need to include dedicated processing devices for simulating or rendering of the virtual environment. Rather, the processing may be centralized at the processing device. Hence, the hardware may be conveniently updated by simply updating the processing device.

In one embodiment, the at least one processing device may be arranged in an external unit.

In another embodiment, the vehicle may comprise the at least one processing device.

In a further embodiment, the at least one sensor is attached to the display device. Preferably, the at least one sensor is configured to measure parameters of the head of the passenger. By directly measuring parameters of the head, the display of the virtual environment may be more closely adapted to the passenger, thereby enabling a more realistic and better matching experience of the virtual environment.

In one embodiment, the at least one display device is a head-mounted display or a see-through device. Accordingly, the passengers may wear the display devices on their heads in order to provide visual stimuli related to the virtual environment to the passengers. Furthermore, the head-mounted display or the see-through device may include loudspeakers or earphones, which may provide corresponding acoustic stimuli to the passengers.

In yet another embodiment, the parameters include a speed of the passenger in relation to the environment. A direct determination of speed of the passenger in relation to the environment is advantageous over other parameters, such as acceleration, since a matching simulation of the virtual environment relies on a correctly determined speed of the passenger. An indirect determination of speed, for example, by measuring acceleration of the passenger, typically leads to an inaccurate determination of the speed. Preferably, the at least one sensor measures the speed, velocity or linear or rotational forces. Further to a speed sensor, the at least one sensor may include further sensors directed at acceleration, including gyroscopic or accelerometer sensor types.

In one embodiment, the measuring of the speed may further include applying one or more of visual imaging, radar technology, and time of flight determination, in any combination. For example, optical flow techniques in visual imaging could be used to determine the speed of the passenger. Radar technology and time of flight approaches may use other signals to determine the speed of the passenger.

In another embodiment, the vehicle further comprises one or more vehicle sensors attached to the vehicle for measuring parameters of the vehicle in relation to the environment. The vehicle sensors may determine a current position and orientation, speed, velocity, acceleration and other linear and rotational parameters of the vehicle. For guided vehicles, such as vehicles that follow a track or a flume or that are attached to a translational and/or rotational assembly, the vehicle sensors may also determine a current position and orientation of the vehicle relative to the guiding means, such as a particular position on a track and/or a current state of the guiding means for simulation and rendering of the virtual environment. Preferably, the at least one processing device may combine, for each passenger, the vehicle parameters and parameters of the passenger to simulate and render the virtual environment for the passenger according to the combined parameters. The vehicle parameters may be used to verify, refine, or adjust the parameters measured for individual passengers using the sensors attached to the passengers. For example, the vehicle sensors may measure a speed of the vehicle, which may be used to verify, refine or adjust the measured parameters of the passengers, for example, by defining a valid speed range or a speed threshold. Yet, it is to be understood that the vehicle parameters are not intended to replace the parameters of individual passengers since this may lead to an inaccurate simulation and rendering of the virtual environment for the passengers.

In another embodiment, the vehicle further comprises a communication interface configured to communicate with the at least one sensor of the at least one support mechanism or with the one or more vehicle sensors. The at least one sensor of the at least one support mechanism and/or the vehicle sensors may be connected with the communication interface using a wired connection or a wireless link. For example, the at least one sensor may be attached or integrated in the at least one display device, which may be directly attached to the head of the passenger, and the at least one sensor may use wireless communication technology for providing the sensor data via the communication interface. Furthermore, the rendering of the virtual environment may be streamed to the display devices via the communication interface.

In a further embodiment, the parameters further include one or more of position and orientation of the passenger or of the head of the passenger, eye gaze information, speed of the passenger, and acceleration of the passenger, in any combination. The further parameters may be used to refine the simulation and rendering of the virtual environment.

In another embodiment, the support mechanism is a seating means for carrying the passenger.

In yet another embodiment, the vehicle is a car, gondola or boat of an amusement ride.

According to another aspect of the present disclosure, an amusement ride including one or more vehicles according to one or more embodiments of the present disclosure is provided.

In one embodiment, two or more of the vehicles are hooked together as a train. Each vehicle of the train may include the processing device for simulating the virtual environment for each passenger of the respective vehicle. However, the train may also include a dedicated vehicle with a central processing device for simulating the virtual environment for each passenger of each vehicle of the train.

In yet another embodiment, the amusement ride is a pendulum ride, a water ride, a drop tower, a swing ride, a train ride or a roller coaster.

According to yet another aspect of the present disclosure, a method for displaying a virtual environment in a vehicle carrying at least one passenger is provided, the method comprising the steps of carrying a passenger of the vehicle in a support mechanism of the vehicle, measuring parameters of the passenger in relation to the environment of the vehicle using at least one sensor attached to the passenger, and displaying a virtual environment to the passenger based on the measured parameters of the passenger.

In yet another embodiment, a non-transitory computer-readable medium storing instructions is provided, wherein the instructions, when installed and/or executed on a computing device, cause the computing device to perform a method according to an embodiment of the present disclosure.

It is to be understood that a vehicle or amusement ride according to an embodiment of the present disclosure may be configured to perform a method according to an embodiment of the present disclosure. Furthermore, a method according to an embodiment of the present disclosure may include method steps reflecting a configuration and processing of structural components of a vehicle or an amusement ride according to one or more embodiments of the present disclosure, in any combination.

The present disclosure enables a realistic provision of a virtual environment to passengers of a vehicle that may be based on measured speed of each passenger in relation to a (real) environment of the vehicle. Since parameters used to simulate and render the virtual environment are directly derived from sensors attached to the passengers, the virtual environment may be better simulated to better correspond to a current sensation of the passengers in the (real) environment of the vehicle.

### DESCRIPTION OF THE DRAWINGS

The specific features, aspects and advantages of the present disclosure will be better understood with regard to the following description and accompanying drawings, where:

FIG. 1 illustrates an amusement ride including a plurality of vehicles according to one embodiment of the present disclosure; and

FIG. 2 shows a method for displaying a virtual environment in a vehicle carrying passengers according to one embodiment of the present disclosure.

### DETAILED DESCRIPTION

In the following description, reference is made to drawings which show by way of illustration various embodiments. Also, various embodiments will be described below by referring to several examples. It is to be understood that the embodiments may include changes in design and structure without departing from the scope of the claimed subject matter.

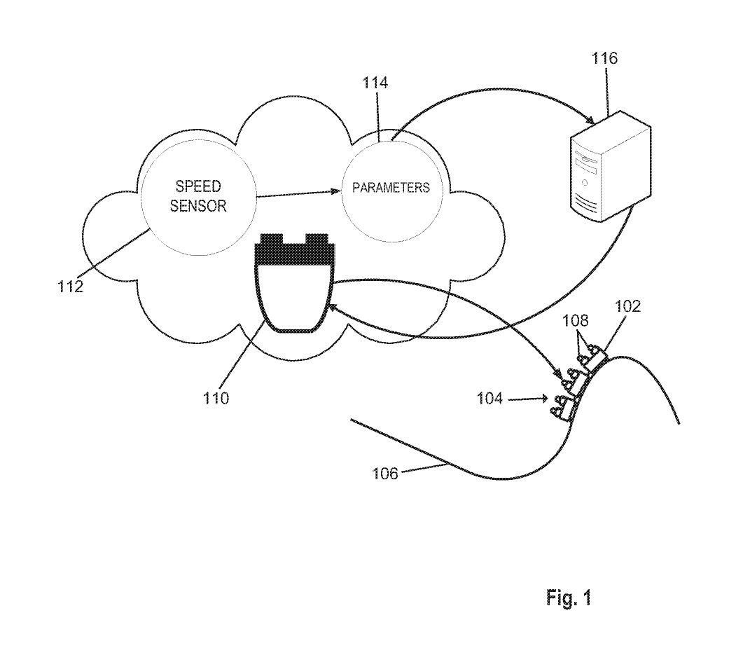

FIG. 1 illustrates an amusement ride according to one embodiment of the present disclosure.

The amusement ride may be a roller coaster, wherein a plurality of cars 102 are hooked together to form a train 104. The train 104 may follow a track 106. Each car 102 of the train 104 may carry one or more passengers 108, which may sit and be restrained in the car 102. However, it is to be understood that the amusement ride is not restricted by a particular number of cars 102 and may rather comprise only one car 102, or more or less than the three cars 102 shown in FIG. 1.

As soon as the train 104 moves along the track 106, the passengers 108 experience corresponding rotational and translational forces.

Each passenger 108 may be seated on a seat in a corresponding vehicle 102 and may wear a head-mounted display device 110, which for illustrative purposes is shown in FIG. 1 separate from the passenger 108. The head-mounted display device 110 may include at least two displays for providing visual images representing a virtual environment to individual eyes of the passenger 108, one or more earphones for presenting acoustic stimuli of the virtual environment, or further output devices for respective stimuli of the virtual environment according to other modalities, such as a force feedback device, an olfactoric output device or a gustatoric output device, and the like, in any combination. Hence, by wearing the head-mounted display device 110, the passenger 108 is provided with an illusion of the virtual environment, which may at least partially or entirely overlay or replace the (real) environment of the amusement ride.

The head-mounted display device 110 may further include at least one speed sensor 112 which may be configured to measure a speed of the passenger 108 in relation to the environment of the train 104. For example, the speed sensor 112 may measure speed using visual imaging, or may include a radar-based technology, or may measure speed based on a time of flight determination. However, it is to be understood that other types of sensors may be used additionally or as an alternative in order to directly measure speed of the passenger 108. Furthermore, the speed sensor 112 may provide further parameters of the passenger, such as linear or rotational forces for each individual passenger 108. The speed sensor 112 may also include a further gyroscopic sensor or an accelerometer. The speed sensor 112 may be directly incorporated into the head-mounted display device 110 or may be communicatively coupled to the head-mounted display device 110 in order to enable a flexible attachment of the speed sensor 112 to the head of a passenger 108.

Speed, as used throughout this disclosure, refers to a scalar value defining a displacement of the passenger 108 over time, such as a rotational speed or a translational speed. The term velocity, as used throughout this disclosure, may refer to a vector indicating a direction of the displacement over time. Hence, speed may be equivalent to an absolute value of velocity. The speed sensor according to the present disclosure may be based on a velocity sensor, wherein the measured velocity may be processed to determine the current speed.

It is to be understood that even though only one speed sensor 112 is shown in FIG. 1, the head-mounted display device 110 may include more sensors of the same or of a different type in order to enable measurement of further parameters of the passenger 108. For example, the head-mounted display device 110 may include at least one sensor for determining a position and orientation of the head of the passenger 108.

The parameters 114 may be transmitted to a processing device 116, which may simulate a virtual environment for each passenger individually, according to the measured parameters 114, or collectively for all passengers of the train 104. For example, the processing device may execute a real-time 3D engine to simulate the virtual environment based on the parameters 114 of one or of all passengers. Subsequently, the parameters 114 may be used to define a camera perspective, including a camera position and orientation, to render the virtual environment for each passenger 108 individually. The rendering may be provided as a media stream, which may be directly streamed to the head-mounted display device 110 of the respective passenger 108. The simulation of the virtual environment may take into account the speed or velocity of each individual user or passenger 108, the speed or velocity of the train 104 and further parameters of the train 104 in order to determine a current camera position and orientation according to a ride through the virtual environment.

The virtual environment may include a model or a representation of the track 106 guiding the train 104, and the speed or velocity and any further parameters may be validated, adjusted or refined according to the representation of the track 106 in the virtual environment, for example, based on one or more thresholds. Since the train 104 moves along the track 106, a measured current position of the passenger may be adjusted according to a threshold offset from the representation of the track 106 in the virtual environment. Furthermore, the scalar speed values may be combined with a direction, which may be derived from a current position and the course of the track 106 as defined by the representation of the track 106 in the virtual environment to refine the parameters for a subsequent simulation and rendering of the virtual environment.

The processing device 116 may be included in each car 102 of the train 104, or may be mounted in a dedicated car of the train 104, such as in a first, a central or a last car 102 of the train 104, to improve communication performance, or may be located external to the train 104, for example, in a control center (not shown) of the amusement ride. In such a case, either the train 104, or individual cars 102, or individual head-mounted display devices 110 may include a communication interface for transmitting the measured parameters 114 to the processing device 116 and for receiving the media streams of the rendered virtual environment.

The amusement ride according to an embodiment enables visitors of amusement parks or other similar locations and environments to have a virtual reality or augmented reality experience that is physically connected to the amusement ride or attraction they are participating in. The speed sensors 112 translate the physical forces of the amusement ride affecting the passengers 108 into virtual or augmented reality output or content that is displayed to the passengers 108 while they are on the ride. The head-mounted display devices 110 may be standard head-mounted displays or see-through displays, which may be equipped with speed sensors to measure speed, velocity, or linear or rotational forces. The sensors 112 may be external to the head-mounted display devices 110 or may be integrated on a chip in the head-mounted display devices 110.

The speed sensors 112 may be based on visual imaging, radar technology or time of flight processing and the resulting data may be processed versus the real world to translate all speed-related information as VR or AR imagery and to manipulate these images to match virtual and physical speed perception of the passengers 108.

The train 104 may comprise further train sensors (not shown), which may be directly attached to the train 104, in order to measure parameters of the train 104. The train sensors may be used to refine the measurements of the speed sensors 112.

It is to be understood that by using dedicated speed sensors 112 for measuring speed, velocity, or linear or rotational forces for each individual passenger 108, instead of relying on a measurement of acceleration, the virtual environment may be simulated and rendered more precisely. Furthermore, by measuring the speed of each individual passenger 108 per head, a great variety of amusement rides may be provided with virtual reality or augmented reality technology, including, but not limited to train rides, pendulum rides, water rides, drop towers, or swing rides.

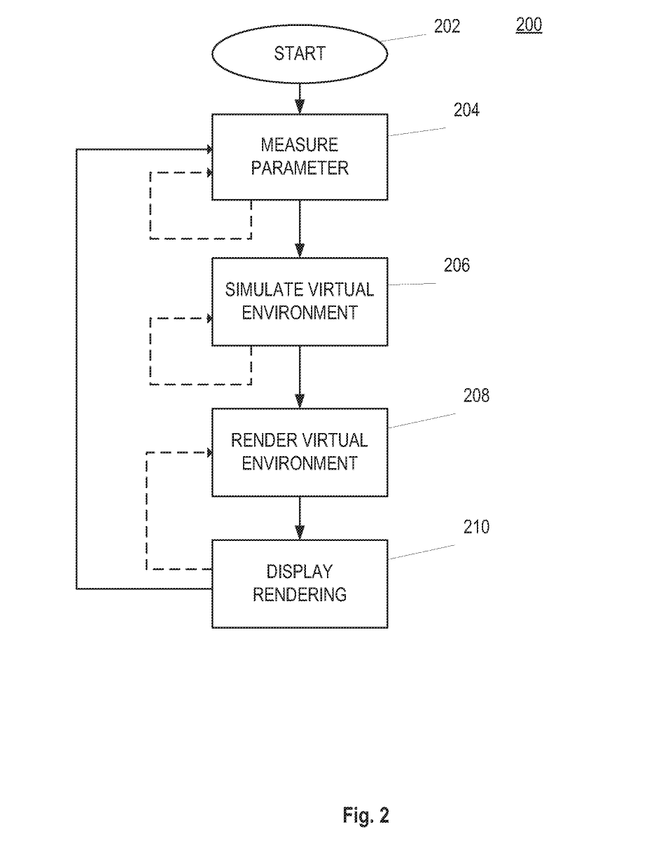

FIG. 2 shows a method for displaying a virtual environment in a vehicle carrying passengers according to one embodiment of the present disclosure. The vehicle may be a car of a train of an amusement ride, such as the car 102 shown in FIG. 1. However, it is to be understood that the method is not limited to a roller coaster amusement ride and may generally be applicable in any other vehicle for passengers, such as a train, a bus, a plane or a vessel.

The method 200 may be initiated in item 202 and may proceed with item 204, wherein parameters of a passenger of the vehicle may be measured in relation to an environment of the vehicle using at least one sensor attached to the passenger. For example, the at least one sensor may be attached to the head of the passenger, thereby providing parameters related to the head of the passenger. For example, the at least one sensor may be at least one speed sensor for measuring one or more of speed, velocity, linear and rotational forces and related parameters, in any combination.

The method 200 may proceed in item 206, wherein a virtual environment may be simulated for each passenger according to the measured parameters of the passenger. The virtual environment may be rendered in item 208. The rendering may correspond to a snapshot of a simulated virtual environment at a particular point in time from a particular camera perspective, which may be affected by the parameters measured in item 204. Hence, both the simulation of the virtual environment in item 206 as well as the rendering of the virtual environment in item 208 may be affected by the parameters measured in item 204. The rendering of the virtual environment may be provided to and displayed on at least one display device of the passenger, such as a head-mounted display or a see-through display, in item 210. The method may reiterate with item 204 by obtaining further parameters. The method may be terminated at any time.

Even though items 204, 206, 208 and 210 are shown in FIG. 2 in sequential order, it is to be understood that one or more of the items may be executed in parallel or concurrently. For example, the parameters may be measured in item 204 continuously and any changes in the measured parameters may be pushed to a processing component simulating the virtual environment in item 206. Hence, after finishing processing in item 204, the method 200 may again directly loop back to item 204, as indicated by the dotted line, and only exchange the measured parameters.

Similarly, simulation of the virtual environment in item 206 may be a continuous processing, which may be controlled by parameters measured in item 204. Hence, after simulating the virtual environment in item 206, the method 200 may loop back to item 206 to continue with simulation of the virtual environment, as indicated by the dotted line.

Furthermore, rendering in item 208 does not need to wait for a completed simulation in item 206. Rather, rendering of the virtual environment may be performed at any point in time, thereby creating a snapshot of the virtual environment at that point in time regardless of a completed simulation. This may be advantageous with regard to real-time constraints in order to provide an immediate response at respective display devices of the passengers. After rendering of the virtual environment in item 208, the method 200 may proceed with display of the rendering in item 210 and may loop back again to item 208, as indicated by the dotted line.

The concurrent and parallel processing of the method 200 enables a fast response and reduces delay time allowing for a seamless provision of the simulated virtual environment for passengers of the vehicle in real time.

While some embodiments have been described in detail, it is to be understood that the aspects of the disclosure can take many forms. In particular, the claimed subject matter may be practiced or implemented differently from the examples described and the described features and characteristics may be practiced or implemented in any combination. The embodiments shown herein are intended to illustrate rather than to limit the invention as defined by the claims.

The embodiments of the invention in which an exclusive property or privilege is claimed are defined as follows:

1. A vehicle for carrying at least one passenger, comprising:
at least one support mechanism, each for carrying a passenger of the vehicle, each support mechanism including:
at least one sensor attached to the passenger for measuring parameters of the passenger in relation to an environment of the vehicle; and
at least one display device for the passenger for displaying a virtual environment to the passenger based on the measured parameters of the passenger.

2. The vehicle according to claim 1, further comprising at least one processing device for simulating the virtual environment for each passenger according to the measured parameters of the passenger and rendering the simulated virtual environment.

3. The vehicle according to claim 2, wherein the rendering generates a media stream for each passenger, wherein the media stream is streamed to the respective at least one display device for the passenger.

4. The vehicle according to claim 1, wherein the at least one sensor is attached to the at least one display device.

5. The vehicle according to claim 4, wherein the at least one sensor is for measuring parameters of the head of the passenger.

6. The vehicle according to claim 1, wherein the at least one display device is a head-mounted display or a see-through device.

7. The vehicle according to claim 1, wherein the parameters include a speed of the passenger in relation to the environment of the vehicle.

8. The vehicle according to claim 7, wherein measuring the speed includes applying one or more of visual imaging, radar technology, and time of flight.

9. The vehicle according to claim 1, further comprising one or more vehicle sensors attached to the vehicle for measuring vehicle parameters of the vehicle in relation to the environment of the vehicle.

10. The vehicle according to claim 9, further comprising at least one processing device, wherein the at least one processing device combines, for each passenger, the vehicle parameters and the parameters of the passenger to simulate the virtual environment for the passenger according to the combined parameters.

11. The vehicle according to claim 1, further comprising a communication interface configured to communicate with the at least one sensor of the at least one support mechanism or one or more vehicle sensors.

12. The vehicle according to claim 1, wherein the parameters further include one or more of position and orientation of the passenger or of the head of the passenger, eye gaze information, speed of the passenger, and acceleration of the passenger.

13. The vehicle according to claim 1, wherein the at least one support mechanism is a seating means for carrying the passenger.

14. The vehicle according to claim 1, wherein the vehicle is a car, gondola, or boat of an amusement ride.

15. An amusement ride including one or more vehicles comprising:
at least one support mechanism, each for carrying a passenger of the vehicle, each support mechanism including:
at least one sensor attached to the passenger for measuring parameters of the passenger in relation to an environment of the vehicle; and
at least one display device for the passenger for displaying a virtual environment to the passenger based on the measured parameters of the passenger.

16. The amusement ride according to claim 15, wherein two or more of the vehicles are hooked together as a train.

17. The amusement ride according to claim 15, wherein the amusement ride is a pendulum ride, a water ride, a drop tower, a swing ride, a train ride or a roller coaster.

18. A method for displaying a virtual environment in a vehicle, comprising:
carrying a passenger of the vehicle in a support mechanism;
measuring parameters of the passenger in relation to an environment of the vehicle using at least one sensor attached to the passenger; and
displaying a virtual environment to the passenger based on the measured parameters of the passenger on at least one display device for the passenger.
